(19) United States
(12) Patent Application Publication
(10) Pub. No.: US 2018/0023555 A1
(43) Pub. Date: Jan. 25, 2018

(54) PUMP FOR OPERATION IN RADIOACTIVE ENVIRONMENT

(71) Applicant: Mallinckrodt Nuclear Medicine LLC, Hazelwood, MO (US)

(72) Inventors: Bryan S. Petrofsky, St. Louis, MO (US); Kevin B. Graves, Catawissa, MO (US)

(21) Appl. No.: 15/407,988

(22) Filed: Jan. 17, 2017

Related U.S. Application Data
(60) Provisional application No. 62/365,709, filed on Jul. 22, 2016.

(51) Int. Cl. F04B 43/08; B65C 3/06; F04B 9/02; G21G 4/08; F04B 43/00; F04B 53/16

(52) U.S. Cl. CPC F04B 43/084; F04B 43/0072; F04B 53/16; F04B 9/02; G21G 4/08; B65C 3/06; A61J 3/00

(57) ABSTRACT

A method of assembling a pump for use in a radioactive environment includes positioning tubing between a rotor and a clamp of the pump. The pump includes a pump head that includes a casing, the rotor, and the clamp. The rotor rotates in relation to the casing. The method also includes rotating the rotor for a first period to compress the tubing against the rotor. The tubing is in a dry condition throughout the first period. The method further includes directing liquid into the tubing and rotating the rotor for a second period to compress the tubing against the rotor and direct the liquid through the pump head. The method also includes calibrating the pump.

### CROSS-REFERENCE TO RELATED APPLICATIONS

This application claims priority to U.S. Provisional Patent Application Ser. No. 62/365,709, filed Jul. 22, 2016, the disclosure of which is hereby incorporated by reference in its entirety.

### FIELD

The field of the disclosure relates generally to liquid handling systems and, more particularly, to a pump for operation in a radioactive environment.

### BACKGROUND

Radioactive material is used in nuclear medicine for diagnostic and therapeutic purposes by injecting a patient with a small dose of the radioactive material, which concentrates in certain organs or regions of the patient. Radioactive materials typically used for nuclear medicine include Germanium-68 (“Ge-68”), Strontium-87m, Technetium-99m (“Tc-99m”), Indium-111m (“In-111”), Iodine-131 (“I-131”) and Thallium-201. Such radioactive materials may be produced using a radionuclide generator. Radionuclide generators generally include a column that has media for retaining a long-lived parent radionuclide that spontaneously decays into a daughter radionuclide that has a relatively short half-life. The column may be incorporated into a column assembly that has a needle-like outlet port that receives an evacuated vial to draw saline or other eluant liquid, provided to a needle-like inlet port, through a flow path of the column assembly, including the column itself. This liquid may elute and deliver daughter radionuclide from the column and to the evacuated vial for subsequent use in nuclear medical imaging applications, among other uses.

During assembly of the radionuclide generators, radioactive materials may be formulated from a raw, concentrated form into a form having a desired concentration. For example, radioactive liquids may be homogeneously mixed, pH-adjusted, sampled, diluted, and dispensed. In addition, the radioactive liquids may be transferred between containers.

Accordingly, a need exists for a liquid handling system that accurately and precisely dispenses liquids and is suitable for use with radioactive materials.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF SUMMARY

In one aspect, a method of assembling a pump for use in a radioactive environment is provided. The pump includes a pump head that includes a casing, a rotor, and a clamp. The rotor rotates in relation to the casing. The method includes positioning tubing between the rotor and the clamp. The tubing is in a dry condition. The method also includes rotating the rotor for a first period to compress the tubing against the rotor. The tubing is in the dry condition throughout the first period. The method further includes directing liquid into the tubing and rotating the rotor for a second period to compress the tubing against the rotor and direct the liquid through the pump head. The method also includes calibrating the pump.

In another aspect, a method of conditioning tubing that is positioned in a pump head of a pump for use in a radioactive environment is provided. The method includes stretching the tubing by operating the pump with the tubing in a dry condition. The tubing has a first temperature. The method also includes connecting the tubing in flow communication with a source of a liquid and directing the liquid through the tubing. The liquid has a second temperature that is less than the first temperature.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a schematic view of a system for producing radionuclide generators.

FIG. 2 is a schematic view of a fluid handling system.

FIG. 3 is an isometric view of a pump head of the fluid handling system shown in FIG. 2.

FIG. 4 is an isometric view of the pump head with a head clamp removed to show a rotor of the pump head.

FIG. 5 is an isometric view of the pump head with a head clamp removed to show tubing extending through the pump head.

FIG. 6 is an isometric view of two dispense stations of the system shown in FIG. 1.

FIG. 7 is a side view of a fill station.

FIG. 8 is an isometric view of a dispensing pump of the fill station shown in FIG. 7.

FIG. 9 is a flow chart of an exemplary method for assembling a pump.

Corresponding reference characters indicate corresponding parts throughout the several views of the drawings.

### DETAILED DESCRIPTION

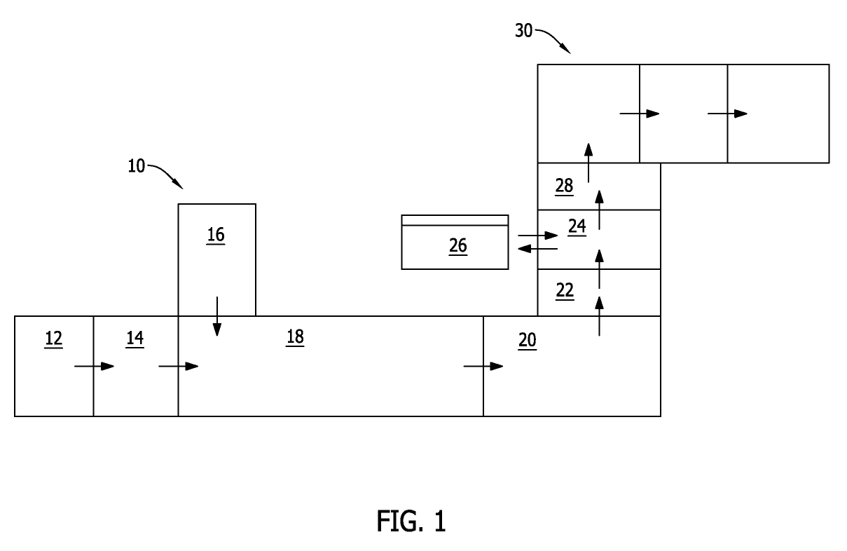

FIG. 1 is a schematic view of a system 10 for manufacturing radionuclide generators. The system 10 shown in FIG. 1 may be used to produce various radionuclide generators, including, for example and without limitation, Technetium generators, Indium generators, and Strontium generators. The system 10 of FIG. 1 is particularly suited for producing Technetium generators. A Technetium generator is a pharmaceutical drug and device used to create sterile injectable solutions containing Tc-99m, an agent used in diagnostic imaging with a relatively short 6 hour radiological half-life, allowing the Tc-99m to be relatively quickly eliminated from human tissue. Tc-99m is “generated” via the natural decay of Molybdenum (“Mo-99”), which has a 66 hour half-life, which is desirable because it gives the generator a relatively long two week shelf life. During generator operation (i.e., elution with a saline solution), Mo-99 remains chemically bound to a core alumina bed (i.e., a retaining media) packed within the generator column, while Tc-99m washes free into an elution vial, ready for injection into a patient. While the system 10 is described herein with reference to Technetium generators, it is understood that the system 10 may be used to produce radionuclide generators other than Technetium generators.

As shown in FIG. 1, the system 10 generally includes a plurality of stations or cells. In the example embodiment, the system 10 includes a cask loading station 12, a formulation station 14, an activation station 16, a fill/wash station 18, an assay/autoclave loading station 20, an autoclave station (“Autoclaves”) 22, an autoclave unloading station 24, a quality control testing station 26, a shielding station 28, and a packaging station 30.

The cask loading station 12 is configured to receive and handle casks or containers of radioactive material, such as a parent radionuclide, and transfer the radioactive material to the formulation station 14. Radioactive material may be transported in secondary containment vessels and flasks that need to be removed from an outer cask prior to formulation. The cask loading station 12 includes suitable tooling and mechanisms to extract secondary containment vessels and flasks from outer casks, as well as to transfer flasks to the formulation cell. Suitable devices that may be used in the cask loading station include, for example and without limitation, telemanipulators.

At the formulation station 14, the raw radioactive material (i.e., Mo-99) is quality control tested, chemically treated if necessary, and then pH adjusted while diluting the raw radioactive material to a desired final target concentration. The formulated radioactive material is stored in a suitable containment vessel (e.g., within the formulation station 14).

Column assemblies containing a column of retaining media (e.g., alumina) are activated at the activation station 16 to facilitate binding of the formulated radioactive material with the retaining media. In some embodiments, column assemblies are activated by eluting the column assemblies with a suitable volume of hydrogen chloride (HCl) at a suitable pH level. Column assemblies are held for a minimum wait time prior to charging the column assemblies with the parent radionuclide.

Following activation, column assemblies are loaded into the fill/wash station 18 using a suitable transfer mechanism (e.g., transfer drawer). Each column assembly is then charged with parent radionuclide by eluting formulated radioactive solution (e.g., Mo-99) from the formulation station 14 through individual column assemblies using suitable liquid handling systems (e.g., pumps, valves, etc.). The volume of formulated radioactive solution eluted through each column assembly is based on the desired curie (Ci) activity for the corresponding column assembly. The volume eluted through each column assembly is equivalent to the total Ci activity identified at the time of calibration for the column assembly. For example, if a volume of formulated Mo-99 required to make a 1.0 Ci Generator (at time of calibration) is ‘X’, the volume required to make a 19.0 Ci Generator is simply 19 times X. After a minimum wait time, the charged column assemblies are eluted with a suitable volume and concentration of acetic acid, followed by an elution with a suitable volume and concentration of saline to “wash” the column assemblies. Column assemblies are held for a minimum wait time before performing assays on the column assemblies.

The charged and washed column assemblies are then transferred to the assay/autoclave load station 20, in which assays are taken from each column assembly to check the amount of parent and daughter radionuclide produced during elution. Each column assembly is eluted with a suitable volume of saline, and the resulting solution is assayed to check the parent and daughter radionuclide levels in the assay. Where the radioactive material is Mo-99, the elutions are assayed for both Tc-99m and Mo-99. Column assemblies having a daughter radionuclide (e.g., Tc-99m) assay falling outside an acceptable range calculation are rejected. Column assemblies having a parent radionuclide (e.g., Mo-99) breakthrough exceeding a maximum acceptable limit are also rejected.

Following the assay process, tip caps are applied to the outlet port and the fill port of the column assembly. Column assemblies may be provided with tip caps already applied to the inlet port. If the column assembly is not provided with a tip cap pre-applied to the inlet port, a tip cap may be applied prior to, subsequent to, or concurrently with tip caps being applied to the outlet port and the fill port. Assayed, tip-capped column assemblies are then loaded into an autoclave sterilizer located in the autoclave station for terminal sterilization. The sealed column assemblies are subjected to an autoclave sterilization process within the autoclave station to produce terminally-sterilized column assemblies.

Following the autoclave sterilization cycle, column assemblies are unloaded from the autoclave station into the autoclave unloading station 24. Column assemblies are then transferred to the shielding station 28 for shielding.

Some of the column assemblies are transferred to the quality control testing station 26 for quality control. In the example embodiment, the quality control testing station 26 includes a QC testing isolator that is sanitized prior to QC testing, and maintained at a positive pressure and a Grade A clean room environment to minimize possible sources of contamination. Column assemblies are aseptically eluted for in-process QC sampling, and subjected to sterility testing within the isolator of the quality control testing station 26. New tip caps are applied to the inlet and outlet needles of the column assemblies before the column assemblies are transferred back to the autoclave unloading station 24.

The system 10 includes a suitable transfer mechanism for transferring column assemblies from the autoclave unloading station 24 (which is maintained at a negative pressure differential, Grade B clean room environment) to the isolator of the quality control testing station 26. In some embodiments, column assemblies subjected to quality control testing may be transferred from the quality control testing station 26 back to the autoclave unloading station 24, and can be re-sterilized and re-tested, or re-sterilized and packaged for shipment. In other embodiments, column assemblies are discarded after being subjected to QC testing.

In the shielding station 28, column assemblies from the autoclave unloading station 24 are visually inspected for container closure part presence, and then placed within a radiation-shielding container (e.g., a lead plug). The radiation shielding container is inserted into an appropriate safe constructed of suitable radiation shielding material (e.g., lead, tungsten or depleted uranium). Shielded column assemblies are then released from the shielding station 28.

In the packaging station 30, shielded column assemblies from the shielding station 28 are placed in buckets pre-labeled with appropriate regulatory (e.g., FDA) labels. A label uniquely identifying each generator is also printed and applied to each bucket. A hood is then applied to each bucket. A handle is then applied to each hood.

The system 10 may generally include any suitable transport systems and devices to facilitate transferring column assemblies between stations. In some embodiments, for example, each of the stations includes at least one telemanipulator to allow an operator outside the hot cell environment (i.e., within the surrounding room or lab) to manipulate and transfer column assemblies within the hot cell environment. Moreover, in some embodiments, the system 10 includes a conveyance system to automatically transport column assemblies between the stations and/or between substations within one or more of the stations (e.g., between a fill substation and a wash substation within the fill/wash station 18).

In the example embodiment, some stations of the system 10 include and/or are enclosed within a shielded nuclear radiation containment chamber, also referred to herein as a “hot cell”. Hot cells generally include an enclosure constructed of nuclear radiation shielding material designed to shield the surrounding environment from nuclear radiation. Suitable shielding materials from which hot cells may be constructed include, for example and without limitation, lead, depleted uranium, and tungsten. In some embodiments, hot cells are constructed of steel-clad lead walls forming a cuboid or rectangular prism. In some embodiments, a hot cell may include a viewing window constructed of a transparent shielding material. Suitable materials from which viewing windows may be constructed include, for example and without limitation, lead glass. In the example embodiment, each of the cask loading station 12, the formulation station 14, the fill/wash station 18, the assay/autoclave loading station 20, the autoclave station, the autoclave unloading station 24, and the shielding station 28 include and/or are enclosed within a hot cell.

In some embodiments, one or more of the stations are maintained at a certain clean room grade (e.g., Grade B or Grade C). In the example embodiment, pre-autoclave hot cells (i.e., the cask loading station 12, the formulation station 14, the fill/wash station 18, the assay/autoclave loading station 20) are maintained at a Grade C clean room environment, and the autoclave unloading cell or station 24 is maintained at a Grade B clean room environment. The shielding station 28 is maintained at a Grade C clean room environment. The packaging station 30 is maintained at a Grade D clean room environment.

Additionally, the pressure within one or more stations of the system 10 may be controlled at a negative or positive pressure differential relative to the surrounding environment and/or relative to adjacent cells or stations. In some embodiments, for example, all hot cells are maintained at a negative pressure relative to the surrounding environment. Moreover, in some embodiments, the isolator of the quality control testing station 26 is maintained at a positive pressure relative to the surrounding environment and/or relative to adjacent stations of the system 10 (e.g., relative to the autoclave unloading station 24).

In this embodiment, the system 10 includes liquid handling systems for handling liquids quickly, accurately, and precisely. At least some of the liquid handling systems are disposed in the hot cells and/or handle radioactive liquids. Accordingly, the liquid handling systems may withstand radiation that would harm people and most electronic equipment. For example, the liquid handling systems may handle a Molybdenum-99 (Mo-99) solution which may deliver a lethal radiation dose in less than 5 minutes to an unprotected observer standing approximately 12 inches away. In other words, operators in the area of the Mo-99 solution would be exposed to a field equal to 5.4 Million millirem per hour (mREM/hr), or 54,000 times greater than the Nuclear Regulatory Commission standard for a high radiation area. As used throughout this disclosure, the term “high radiation area” refers to an area in which radiation levels exceed 100 mREM/hr at 30 centimeters from the radiation source.

The described liquid handling systems withstand the relatively high radiation doses in the high radiation area with minimal deterioration. Moreover, the liquid handling systems are unshielded to reduce the amount of space occupied by the liquid handling systems. The liquid handling systems may be used to transport any liquids, including radioactive and nonradioactive materials. For example, the liquid handling systems may dispense high radioactive pharmaceutical liquids such as clean injectable solutions. At least some of the liquid handling systems automatically dispense the liquids. In alternative embodiments, the system 10 may include any liquid handling systems that enable the system 10 to operate as described.

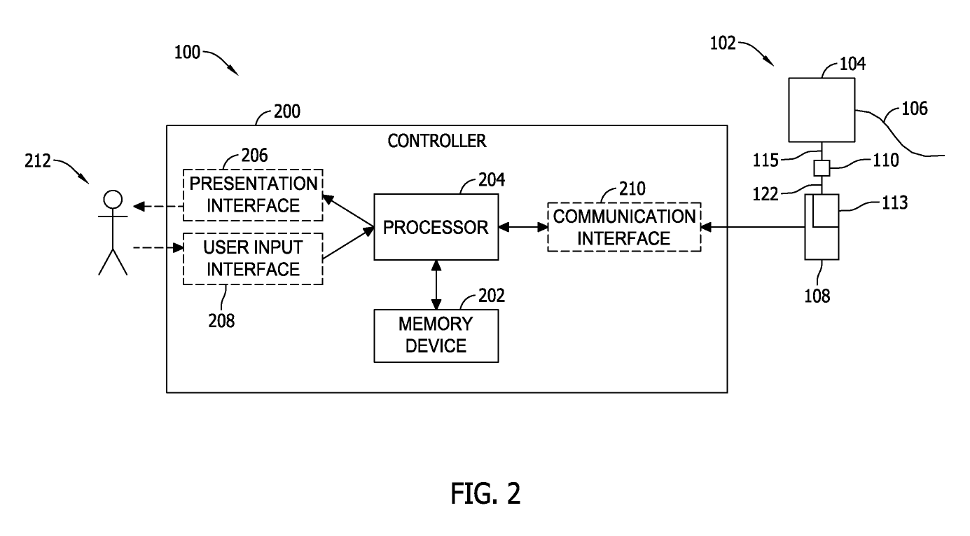

FIG. 2 is a schematic view of a liquid handling system 100 for use with the system 10. In this embodiment, the liquid handling system 100 includes at least one positive displacement pump 102, or more specifically, a peristaltic pump, and a controller 200. Each pump 102 includes a pump head 104, tubing 106, a servomotor 108 with power and feedback cabling, and a coupling 110 connecting the pump head to the servomotor.

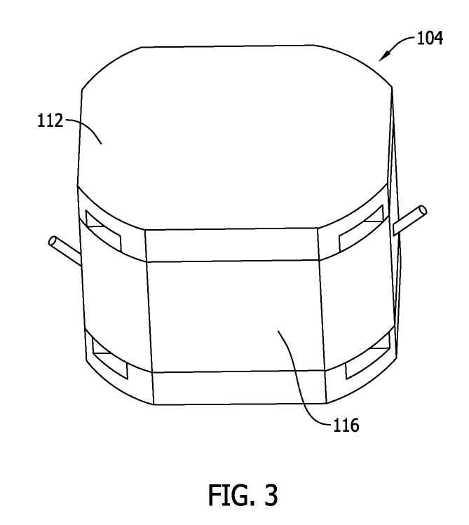

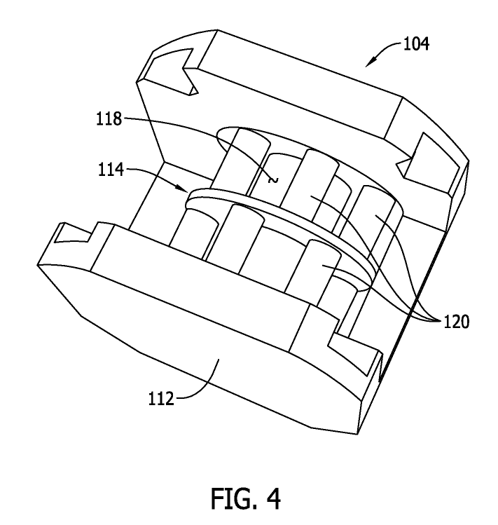

In reference to FIGS. 2-5, the pump head 104 includes a casing 112, a rotor 114 with a keyed shaft 115, and a head clamp 116. The casing 112 defines an interior space 118 and at least partially encloses the rotor 114. The head clamp 116 compresses tubing 106 against the rotor 114. The rotor 114 rotates in relation to the casing 112 within the interior space 118. The servomotor 108 controls the rotation of the rotor 114 and transmits signals relating to the rotation of the rotor. One example of a suitable pump head is a FLEXICON pump head available from WATSON-MARLOW, INC.

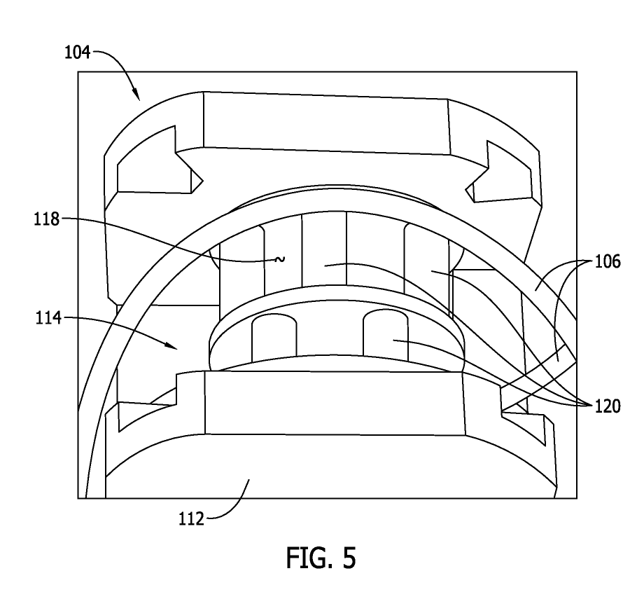

In reference to FIG. 5, the tubing 106 generally extends through the pump head 104 and transports liquid through the pump 102. The rotor 114 includes a plurality of rotor heads 120 that are spaced from the head clamp 116 a distance less than the outer diameter of the tubing 106. The tubing 106 is compressed between the rotor heads 120 and the head clamp 116. The rotor heads 120 move along the tubing 106 as the rotor 114 rotates. As a result, liquid in the tubing 106 is directed through the pump head 104 as the rotor 114 rotates. Accordingly, in this embodiment the pump 102 is a peristaltic pump. In alternative embodiments, the liquid handling systems 100 may include any pumps 102 that enable the liquid handling systems to function as described.

For example, the pump 102 may dispense liquids at a speed of approximately 12 milliliters per second (mL/sec) using 3.2 millimeters (mm) ID-tubing. The pump 102 of this embodiment dispenses liquids without the use of a nozzle. The volume of liquid dispensed may be in range of about 2.5 milliliters (mL) to about 60 mL. The accuracy limitations may depend on the size and type of the tubing 106. For example, a smaller ID tubing may allow greater accuracy for smaller dispense volumes. In this embodiment, the tubing 106 is made of silicone. Accordingly, the tubing 106 may be removed and replaced to eliminate cross-contamination between batches, and to remove radioactively contaminated consumables from the area. An example of suitable silicone tubing is FLEXICON ACCUSIL tubing available from WATSON-MARLOW, INC. In alternative embodiments, the liquid handling systems 100 may include any tubing 106 that enables the liquid handling systems 100 to operate as described.

In some embodiments, the tubing 106 may be conditioned, or “broken-in”, prior to calibration and/or operation of the pump 102. For example, the tubing 106 may be conditioned by positioning the tubing in a dry condition within the pump head 104 and operating the pump without directing liquid through the tubing. As used throughout this disclosure, the term “dry condition” refers to a condition where the tubing does not contain liquid. The term “dry operation” refers to operation of the pump without directing liquid through the tubing 106. The dry operation of the pump 102 may last for any suitable period. Also, the rotor 114 may be rotated at any speed during dry operation. For example, the rotor 114 may be rotated at approximately 300 revolutions per minute (RPMs) or greater for at least about 6,000 cumulative seconds. In this embodiment, the rotor 114 is rotated at approximately 350 RPMs for at least 7,200 continuous seconds during the dry operation. The dry operation of the pump 102 at least partially deforms the tubing 106. In some embodiments, the pump 102 may be stopped and restarted during the dry operation. After the dry operation, the tubing 106 is maintained in the same position and a liquid is directed into the tubing. In this embodiment, water is directed into the tubing 106. In other embodiments, any suitable liquid may be used. The liquid reduces the temperature of the tubing 106 and facilitates setting the tubing in a conditioned state. The liquid is directed through the tubing 106 by rotating the rotor 114 and the liquid is dispensed from the pump 102. In some embodiments, the pump 102 may dispense at least 1,000 shots of the liquid. In this embodiment, the pump 102 dispenses 1,500 shots of the liquid. Each shot includes approximately 10 milliliters (mL) of the liquid. In other embodiments, any amount of the liquid may be directed through the tubing 106 and dispensed from the pump 102. In some embodiments, the tubing 106 may be conditioned without directing liquid through the tubing. For example, for pumps 102 which pump only non-radioactive liquid, the tubing 106 may be conditioned by operating the pump with the tubing 106 in the dry condition for approximately 3,600 seconds. After conditioning of the tubing 106, the pump 102 is calibrated and prepared for normal operation.

Due to the conditioning of the tubing 106, the tubing deforms less during normal operation of the pump 102. For example, the tubing 106 may be stretched beyond an elastic limit during tubing conditioning, such that the tubing remains in a deformed, i.e., stretched state, after conditioning. As a result, the conditioned tubing 106 will have reduced elasticity. In contrast, previous systems sought to reduce stretching of the tubing to prolong the service life of the tubing. As a result, the tubing stretched and deformed during normal operation of the pump 102. In the system described herein, the conditioned tubing 106 will deform less than the previous systems during normal operation of the pump 102 because the tubing has already been stretched and deformed. As a result, the pump 102 may operate with increased accuracy and precision throughout a batch.

After operation of the pump 102 for a specified duration, recalibration of the pump may be required. However, in the embodiments described herein, the pump 102 may operate for a longer duration without recalibration. In particular, the tubing conditioning reduces inconsistencies and inaccuracies of dispensed liquid that require pump recalibration by reducing deformation, such as stretching, of the tubing 106 during normal operation of the pump 102. As a result, the pump 102 may operate for increased periods between calibrations. For example, the pump 102 may dispense up to 2,000 mL, up to 3,000 mL, up to 3,500 mL, up to 4,000 mL, up to 4,500 mL, up to 5,000 mL, up to 5,500 mL, up to 6,000 mL, up to 6,500 mL, up to 7,000 mL, up to 7,500 mL, up to 8,500 mL, up to 9,500 mL, up to 10,000 mL, and even up to 50,000 mL before pump recalibration is required. In particular, the dispense volume of the pump 102 may remain within acceptable limits throughout the batch. As a result, the pump 102 may dispense an entire production batch without recalibration. The conditioned tubing 106 is particularly advantageous when used in pumps 102 that dispense radioactive materials, such as fill pumps 300, described in more detail below, because it reduces the need to recalibrate the pumps during production, and thereby reduces the associated risks of handling radioactive material during the recalibration process.

The liquid handling system 100 is able to withstand high levels of radiation. For example, the pump head 104, shafts 115 and 122, couplings 110, motors 108, feedback mechanisms 113, and cabling 130 are able to withstand high levels of radiation. Electrical cabling is insulated using materials, such as polyurethane, that are suitable to withstand high levels of radiation.

In some embodiments, the pump head 104 and servomotor 108 are spaced apart and connected by a shaft 115 and a plurality of couplings 110. In further embodiments, the shaft 115 and/or couplings 110 are angled to allow the pump head 104 and servomotor 108 to be spaced apart in more than one direction. In addition, the pump head 104 can be segregated and sealed in a clean environment for aseptic dispensing and sanitization, without exposing clean production areas to pump control hardware. In some embodiments, the pump head 104 is a pharmaceutical-grade pump head. As used herein, the term “pharmaceutical-grade” refers to equipment that withstands sanitization and is fabricated from non-oxidizing materials. In addition, pharmaceutical-grade equipment does not have recessed or pointed surfaces. For example, pharmaceutical-grade equipment may be manufactured from 316 gauge stainless steel and include rounded corners and flush surfaces.

In this embodiment, a zero-backlash coupling 110 is positioned between the pump head 104 and the servomotor 108, keyed at the pump head shaft 115 and the motor shaft 122. Accordingly, the keyed coupling 110 eliminates backlash between the pump head 104 and rotor 114. In alternative embodiments, the liquid handling system 100 includes any coupling 110 that enables the liquid handling system to function as described.

The servomotor 108 may be a servomotor controlled by a programmable logic controller (PLC) to allow highly accurate and repeatable motion control. In addition, the servomotor 108 may be an AC servomotor with resolver feedback. In alternative embodiments, the pump 102 may include any servomotors that enable the liquid handling system 100 to operate as described.

The servomotor 108 can control pump head 104 acceleration, deceleration, speed, and/or motion profile. For example, the servomotor 108 can control acceleration of the rotor 114 from a stopped position. In addition, the servomotor 108 can maintain the rotor 114 at a steady state speed and can control deceleration of the rotor. Moreover, the servomotor 108 can provide a desired motion profile including trapezoidal (linear ramp velocities) or S-curve (linear acceleration/deceleration). The relatively high torque capacity of the servomotor 108 and resolver-based feedback reduces stalling and slipping from commanded motion profiles. For example, the servomotor 108 is suitably a high torque servomotor, such as a servomotor utilizing 480 volts of alternating current (3-phase) with fine continuous resolver-based feedback. The coupling 110 between the servomotor 108 and the pump head 104 eliminates slippage and error due to the rotational inertia of the servomotor or pump head. High torque allows the servomotor 108 to overcome rotor resistance against liquid-filled tubing. The pump head rotation and any other motion parameters may be controlled via one logic instruction.

The servomotor 108 is equipped with a resolver-based feedback mechanism that is radiation-tolerant. A resolver 113 continuously tracks rotation of the rotor 114. In this embodiment, the resolver 114 is magnetic. In alternative embodiments, the servomotor 108 may include any resolver 113 that enables the servomotor to operate as described. In further embodiments, the resolver 113 is omitted.

The resolver 113 may provide feedback of at least about 200,000 steps per 360-degree revolution of the rotor 114. Accordingly, the servomotor 108 may compare planned rotational movement to actual rotational movement for 1/200,000^{th} of a revolution while following a specific start-to-end motion profile. If rotation of the rotor 114 is interrupted for any reason (e.g. power loss, servo drive fault, etc.), the fluid application system 100 is able to accurately recover and complete the original dispense because the resolver 113 automatically tracks exactly what portion of the original motion was completed, and what portion remains.

Embodiments of the servomotor 108 (including the integrated resolver) were tested by exposing the servomotors to 400 kilograys of ionizing radiation from a Cobalt-60 (Co-60) source. The Co-60 source provided an equivalent of 40 Million REMs gamma radiation exposure. The servomotor 108 was bench-tested before and after irradiation. Bench-testing results did not indicate a degradation of performance after irradiation. The tested exposure of 400 kilograys of radiation represents 20 years of expected Mo-99 radiation exposure at an unshielded worst-case proximity.

The pumps 102 may be used to dispense non-radioactive liquid and/or radioactive liquid inside and outside of the hot cell. For example, the pumps 102 may dispense acetic acid, purified water for injection, and/or any other liquids. The liquids may be used to activate a material in column assemblies, to wash column assemblies, and/or to test column assemblies. Accordingly, the pumps 102 may be included in any cells of the system 10 such as an activation cell, a formulation cell, a fill cell, a wash cell, and an assay cell.

In reference to FIG. 2, the controller 200 includes at least one memory device 202 and a processor 204 that is coupled to the memory device 202 for executing instructions. In this embodiment, executable instructions are stored in the memory device 202, and the controller 200 performs one or more operations described herein by programming the processor 204. For example, the processor 204 may be programmed by encoding an operation as one or more executable instructions and by providing the executable instructions in the memory device 202.

The processor 204 may include one or more processing units (e.g., in a multi-core configuration). Further, the processor 204 may be implemented using one or more heterogeneous processor systems in which a main processor is present with secondary processors on a single chip. As another illustrative example, the processor 204 may be a symmetric multi-processor system containing multiple processors of the same type. Further, the processor 204 may be implemented using any suitable programmable circuit including one or more systems and microcontrollers, microprocessors, programmable logic controllers (PLCs), reduced instruction set circuits (RISC), application specific integrated circuits (ASIC), programmable logic circuits, field programmable gate arrays (FPGA), and any other circuit capable of executing the functions described herein. In this embodiment, the processor 204 controls operation of the fluid handling systems by outputting control signals to components of the fluid handling system. Further, in this embodiment, the processor 204 determines a dispense volume based on program instructions and/or user inputs.

The memory device 202 is one or more devices that enable information such as executable instructions and/or other data to be stored and retrieved. The memory device 202 may include one or more computer readable media, such as, without limitation, dynamic random access memory (DRAM), static random access memory (SRAM), a solid state disk, and/or a hard disk. The memory device 202 may be configured to store, without limitation, application source code, application object code, source code portions of interest, object code portions of interest, configuration data, execution events and/or any other type of data.

In this embodiment, the controller 200 includes a presentation interface 206 that is connected to the processor 204. The presentation interface 206 presents information, such as application source code and/or execution events, to a user 212, such as a technician or operator. For example, the presentation interface 206 may include a display adapter (not shown) that may be coupled to a display device, such as a cathode ray tube (CRT), a liquid crystal display (LCD), an organic LED (OLED) display, and/or an “electronic ink” display. The presentation interface 206 may include one or more display devices. In this embodiment, the presentation interface 206 displays the dispense and/or transfer volumes of the fluid handling system.

The controller 200 also includes a user input interface 208 in this embodiment. The user input interface 208 is connected to the processor 204 and receives input from the user 212. The user input interface 208 may include, for example, a keyboard, a pointing device, a mouse, a stylus, a touch sensitive panel (e.g., a touch pad or a touch screen), a gyroscope, an accelerometer, a position detector, and/or an audio user input interface. A single component, such as a touch screen, may function as both a display device of the presentation interface 206 and the user input interface 208.

In this embodiment, the controller 200 further includes a communication interface 210 connected to the processor 204. The communication interface 210 communicates with one or more remote devices, such as the servomotor 108. In this embodiment, the controller 200 is separated from the servomotor 108 and located outside of the radioactive environment. In some embodiments, at least a portion of the controller 200 may be integrated with the servomotor 108. In alternative embodiments, the controller 200 may include any component that enables the fluid handling system to operate as described.

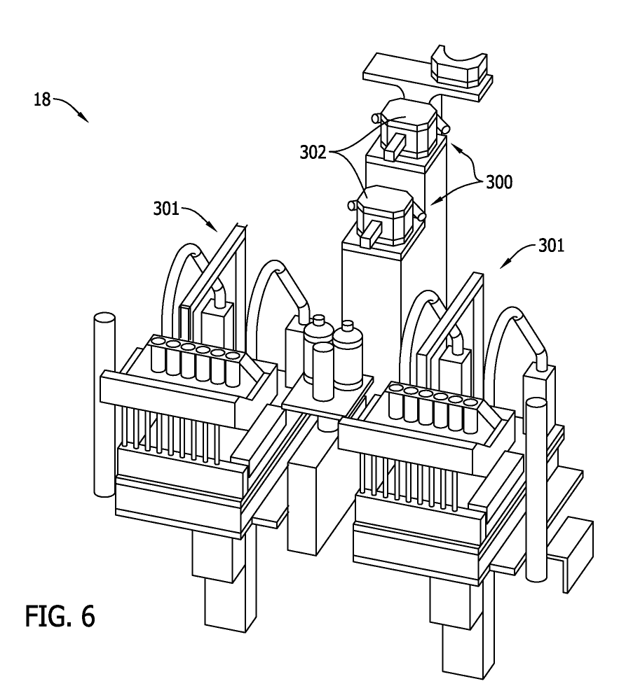

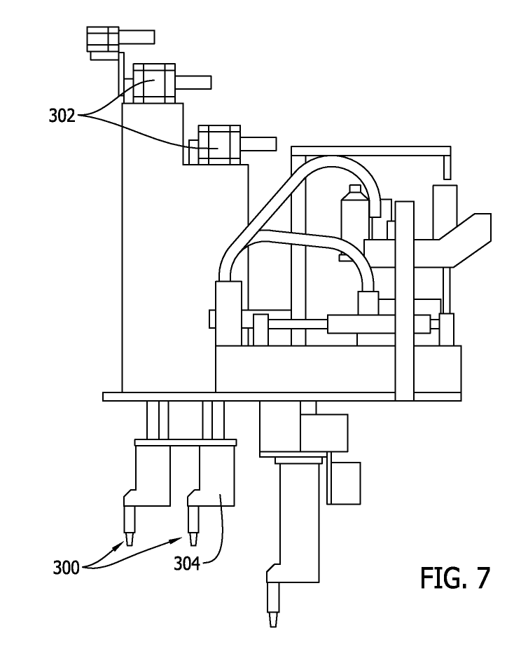

FIG. 6 is an isometric view of a fill station 18 of the system 10. FIG. 7 is a side view of the fill station 18. The fill station 18 includes two fill pumps 300 to dispense radioactive liquid inside the hot cells. In alternative embodiments, the fill station 18 may include any pump 300 that enables the system 10 to operate as described. In addition, the fill station 18 includes arms 301 that rotate and support tubing 106. The arms 301 provide consistent support to the tubing 106 and prevent binding of the tubing. In this embodiment, the fill station 18 includes two arms 301, one for each dispensing station. In alternative embodiments, the fill station 18 may include any components that enable the fill station to operate as described.

The fill pumps 300 may be used to dispense any nonradioactive and radioactive liquids. In this embodiment, the fill pumps 300 dispense Mo-99 into the column assemblies. The fill pumps 300 dispense an accurate and precise amount of the radioactive liquid into the column assemblies within very strict tolerances. For example, the fill pumps 300 may achieve dispense tolerances better than +/−1.0% of a target volume, better than +/−0.1% of a target volume, better than +/−0.01% of a target volume, better than +/−0.001% of a target volume, and even up to +/−0.0001% of a target volume. Use of conditioned tubing, described above, in fill pumps 300 facilitates maintaining dispense accuracy and volumes within acceptable tolerance limits throughout an entire production batch of column assemblies. In some embodiments, for example, conditioning the tubing as described herein may result in dispense tolerances being maintained at better than +/−5.0% of a target volume, better than +/−2.5% of a target volume, better than +/−2.0% of a target volume, better than +/−1.0% of a target volume, better than +/−0.75% of a target volume, better than +/−0.60% of a target volume, or even better than +/−0.50% of a target volume for cumulative dispense volumes of up to 2,000 mL, up to 3,000 mL, up to 3,500 mL, up to 4,000 mL, up to 4,500 mL, up to 5,000 mL, up to 5,500 mL, up to 6,000 mL, up to 6,500 mL, up to 7,000 mL, up to 7,500 mL, up to 8,500 mL, up to 9,500 mL, up to 10,000 mL, and even up to 50,000 m L.

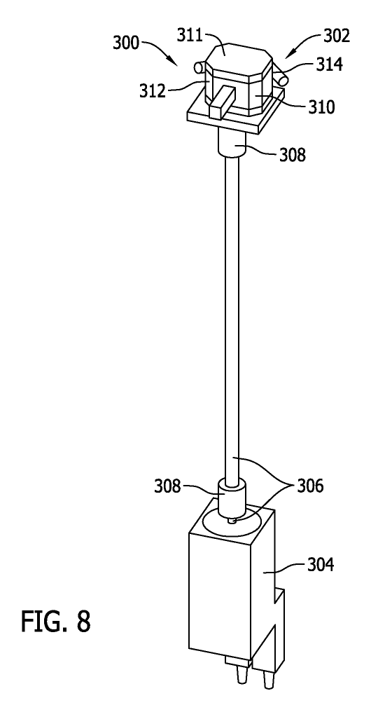

FIG. 8 is an isometric view of one of the fill pumps 300. The fill pump 300 includes a pump head 302, a servomotor 304 with power and feedback cabling, keyed shafts 306, and keyed couplings 308. The shafts 306 and the couplings 308 extend between and connect the pump head 302 and the servomotor 304. Accordingly, the pump head 302 can be positioned in a clean processing area and the servomotor 304 can be positioned a distance from the pump head 302 to separate the servomotor from the clean processing area.

The pump head 302 includes a head clamp 310, a casing 311, a rotor, a liquid inlet 314, and a liquid outlet 312. During operation of the pump 300, liquid enters the casing 311 through the liquid inlet 314, the liquid is directed through the pump head 302 by a rotor within the pump head 302, and the liquid exits the casing 311 through the liquid outlet 312.

The keyed shafts 306 and couplings 308 allow the servomotor 304 to control rotational movement of the rotor within the pump head 302. In particular, the couplings 308 connect a middle shaft 306 to the pump head shaft 306 and the servomotor shaft 306. The couplings 308 are of zero-backlash type, and include keying features that prevent rotational slippage at the pump head shaft and at the servomotor shaft. Accordingly, the couplings 308 and the keyed shafts 306 eliminate backlash during motor and pump movement. In alternative embodiments, the pump 300 includes any couplings and shafts that enable the pump 300 to operate as described.

The servomotor 304 controls the pump head and thus the dispensing of liquid. A programmable logic controller (PLC) controls an external servo drive, which controls servomotor 304, which precisely controls the pump head. Control is intrinsic to the PLC. Examples of control settings for the servomotor are shown in the chart below.

Servomotor Settings for Dispensing a Radioactive Liquid

| Setting | Fill Low Volume | Fill High Volume |
|---|---|---|
| Dispense Volume (mL) | <12.0 | >=12.0 |
| Velocity (mL/s) | 13.0 | 13.0 |
| Acceleration (mL/s2) | 20.0 | 40.0 |
| Deceleration (mL/s2) | 40.0 | 20.0 |
| Motion Profile | S-Curve | S-Curve |

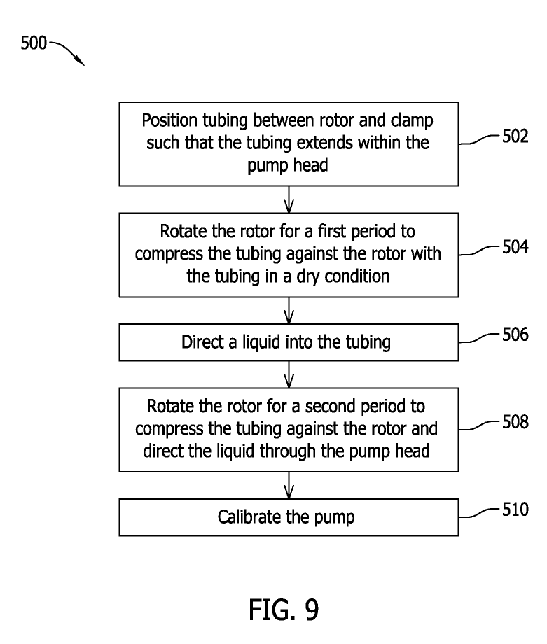

FIG. 9 is a flow chart of a method 500 for assembling a pump 102. In reference to FIGS. 5 and 9, the method 500 generally includes positioning 502 tubing 106 between the rotor 114 and the clamp 116 of the pump 102 such that the tubing extends within the pump head 104. The method 500 also includes rotating 504 the rotor 114 for a first period to compress the tubing 106 against the rotor with the tubing in a dry condition. This dry operation of the pump 102 deforms, e.g., stretches, the tubing 106 and increases the temperature of the tubing. The method 500 further includes directing 506 liquid into the tubing 106. In particular, in this embodiment, the tubing 106 is connected in flow communication with a source of liquid and the liquid is allowed to flow into the tubing such that the liquid is directed through the tubing during operation of the pump 102. The method 500 also includes rotating 508 the rotor 114 for a second period to compress the tubing 106 against the rotor and direct the liquid through the pump head 104. In this embodiment, the liquid includes water. In other embodiments, any liquid may be directed through the tubing 106 that enables the pump 102 to operate as described herein. In this embodiment, the liquid has a temperature that is less than a temperature of the tubing 106. As a result, the liquid decreases the temperature of the tubing 106 and facilitates setting the tubing in the conditioned state. In suitable embodiments, the liquid may have any temperature that enables the pump 102 to operate as described herein. The method 500 further includes calibrating 510 the pump 102. The tubing 106 is maintained in the position between the rotor 114 and the clamp 116 throughout the assembly and operation of the pump 102 until it is necessary to replace the tubing.

### Example

Experimental testing was conducted on two pumps, referred to as Pumps A and B, utilizing tubing that was conditioned as described above. The pumps were peristaltic pumps having substantially the same configuration as fill pumps 300 described above with reference to FIGS. 5-7. Each pump included a FLEXICON pump head and FLEXICON ACCUSIL silicone tubing. Prior to testing, the tubing was conditioned by positioning the tubing in a dry condition within the pump heads and the pumps were operated without directing liquid through the tubing. The rotors were rotated at approximately 350 RPMs for at least 7,200 continuous seconds during the dry operation. After the dry operation, the tubing was maintained in the same position and water was directed into the tubing and dispensed from the pumps. Each pump dispensed at least 1,500 shots of the liquid. Each shot included approximately 10 mL of the liquid. After conditioning of the tubing, the pumps were calibrated and prepared for testing.

During the test, each pump was set up to dispense varying target volumes of radioactive fluid based on target curie (Ci) levels of radiation. The radioactive fluid dispensed through the pumps was formulated Mo-99 having a concentration of 0.35 curies per milliliter (Ci/mL), and the target volumes were calculated based on a maximum concentration of 0.385 Ci/mL. During each test, the target volume for each pump was cycled through 5 different target volumes for varying intervals over the course of the test. The target volumes and corresponding target radiation levels used were 2.597 mL for a 1.0 Ci generator, 5.195 mL for a 2.0 Ci generator, 6.494 mL for a 2.5 Ci generator, 19.481 mL for a 7.5 Ci generator, and 49.351 mL for a 19.0 Ci generator. Each test was conducted until each pump reached a cumulative dispense volume of at least 5,500 mL. The individual dispense or “shot” volumes dispensed by Pump A and Pump B during each test were recorded and compared to the corresponding target volume. The test results for Pump A and Pump B are listed below in Tables 1 and 2, respectively. Each table shows the target radiation levels, the corresponding target volumes, the minimum and maximum dispensed volume recorded for each target volume, and the corresponding lower and upper percentage limits.

TABLE 1
Test Results Pump A

| | Target | Minimum | | Maximum | |
|---|---|---|---|---|---|
| Target | Volume | Dispensed | Lower | Dispensed | Higher |
| Level (Ci) | (mL) | Volume (mL) | limit | Volume (mL) | limit |
| 1.0 | 2.597 | 2.550 | −1.83% | 2.649 | +1.99% |
| 2.0 | 5.195 | 5.157 | −0.73% | 5.300 | +2.02% |
| 2.5 | 6.494 | 6.406 | −1.35% | 6.547 | +0.82% |
| 7.5 | 19.481 | 19.285 | −1.00% | 19.492 | +0.06% |
| 19.0 | 49.351 | 48.980 | −0.75% | 49.336 | −0.03% |

TABLE 2
Test Results Pump B

| | Target | Minimum | | Maximum | |
|---|---|---|---|---|---|
| Target | Volume | Dispensed | Lower | Dispensed | Higher |
| Size (Ci) | (mL) | Volume (mL) | limit | Volume (mL) | limit |
| 1.0 | 2.597 | 2.549 | −1.86% | 2.647 | +1.91% |
| 2.0 | 5.195 | 5.165 | −0.57% | 5.295 | +1.93% |
| 2.5 | 6.494 | 6.407 | −1.33% | 6.543 | +0.76% |
| 7.5 | 19.481 | 19.339 | −0.73% | 19.511 | +0.16% |
| 19.0 | 49.351 | 49.041 | −0.63% | 49.476 | +0.25% |

As shown in the tables above, the pumps with conditioned tubing maintained dispense tolerances better than +/−2.5% for all target volumes over a cumulative dispense volume of at least 5,500 mL. Further, at least one pump (Pump B) maintained dispense tolerances better than +/−2.0% for all target volumes over a cumulative dispense volume of at least 5,500 mL. Dispense tolerances for target volumes greater than 20 mL were maintained at better than +/−0.75% over a cumulative dispense volume of at least 5,500 mL. Dispense tolerances for target volumes between 7 mL and 20 mL were maintained at better than +/−1.0% over a cumulative dispense volume of at least 5,500 mL. Dispense tolerances for target volumes between 6 mL and 7 mL were maintained at better than +/−1.0% over a cumulative dispense volume of at least 5,500 mL. Dispense tolerances for target volumes less than 5 mL were maintained at better than +/−2.0% over a cumulative dispense volume of at least 5,500 m L.

The liquid handling systems described above achieve superior results compared to some known systems and methods. The liquid handling systems dispense accurate and precise volumes of nonradioactive and radioactive liquids. In addition, the liquid handling systems are not sensitive to radiation levels. The liquid handling systems include tubing that has been conditioned to reduce tubing deformation during operation of the liquid handling systems. Conditioning the tubing reduces inaccuracies and inconsistencies during operation of the liquid handling systems that would otherwise result from tubing deformation. Accordingly, the conditioned tubing increases the precision of the liquid handling systems. In addition, the conditioned tubing reduces the need for calibration of the liquid handling systems during a batch, which reduces downtime and increases the operating efficiency of the liquid handling systems.

The liquid handling systems also reduce contamination during processing of radioactive materials. The liquid handling systems include disposable tubing that contains radiological contamination and may be replaced after use to eliminate chemical and biological contamination between batches. Moreover, the risk of radioactive material leaking during calibration is reduced because the need to recalibrate the pump during a batch is reduced.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A method of assembling a pump for use in a radioactive environment, the pump including a pump head that includes a casing, a rotor, and a clamp, the rotor rotating in relation to the casing, the method comprising:
positioning tubing between the rotor and the clamp, wherein the tubing is in a dry condition;
rotating the rotor for a first period to compress the tubing against the rotor, wherein the tubing is in the dry condition throughout the first period;
directing liquid into the tubing;
rotating the rotor for a second period to compress the tubing against the rotor and direct the liquid through the pump head; and
calibrating the pump.

2. The method of claim 1, wherein rotating the rotor to compress the tubing against the rotor comprises rotating the rotor at a speed of at least 300 revolutions per minute.

3. The method of claim 2, wherein rotating the rotor to compress the tubing against the rotor comprises rotating the rotor for at least 6,000 cumulative seconds.

4. The method of claim 1 further comprising dispensing liquid from the pump, wherein the liquid is dispensed in discrete shots.

5. The method of claim 4, wherein dispensing liquid from the pump comprises dispensing at least 1,000 shots, and each shot includes approximately 10 milliliters.

6. The method of claim 1 further comprising dispensing radioactive liquid from the pump.

7. The method of claim 1 further comprising increasing the temperature of the tubing as the tubing is stretched, the tubing having a first temperature after stretching.

8. The method of claim 7 further comprising decreasing the temperature of the tubing as the liquid is directed through the tubing, the tubing having a second temperature after the liquid is directed through the tubing, wherein the second temperature is less than the first temperature.

9. The method of claim 1 further comprising:
dispensing discrete volumes of radioactive liquid from the pump based on a target dispense volume; and
maintaining a tolerance within +/−2.0% of the target dispense volume over a cumulative dispense volume of at least 5,500 mL.

10. The method of claim 9, wherein the target dispense volume is less than 50 mL.

11. The method of claim 9, wherein the target dispense volume is less than 5 mL.

12. The method of claim 9, wherein the target dispense volume is between 20 mL and 50 mL, and wherein maintaining a tolerance within +/−2.0% of the target dispense volume comprises maintaining a tolerance within +/−1.0% over a cumulative dispense volume of at least 5,500 mL.

13. A method of conditioning tubing that is positioned in a pump head of a pump for use in a radioactive environment, the method comprising:
stretching the tubing by operating the pump with the tubing in a dry condition, the tubing having a first temperature;
connecting the tubing in flow communication with a source of a liquid; and
directing the liquid through the tubing, wherein the liquid has a second temperature that is less than the first temperature.

14. The method of claim 13, further comprising rotating a rotor of the pump head for a first period to compress the tubing against the rotor.

15. The method of claim 14, wherein rotating the rotor to compress the tubing against the rotor comprises rotating the rotor at a speed of at least 300 revolutions per minute.

16. The method of claim 14 further comprising rotating the rotor for a second period to compress the tubing against the rotor and direct the liquid through the tubing.

17. The method of claim 13, wherein stretching the tubing by operating the pump with the tubing in a dry condition comprises stretching the tubing by operating the pump with the tubing in a dry condition for at least 6,000 cumulative seconds.

18. The method of claim 13 further comprising dispensing liquid from the pump, wherein the liquid is dispensed in discrete shots, each shot including approximately 10 milliliters (mL).

19. The method of claim 18, wherein dispensing liquid from the pump comprises dispensing at least 1,000 shots.

20. The method of claim 13 further comprising positioning tubing between a rotor and a clamp, wherein the tubing is in the dry condition.
